(19) United States
(12) Patent Application Publication
(10) Pub. No.: US 2022/0309516 A1
(43) Pub. Date: Sep. 29, 2022

(54) AUTOMATED ACCOUNT MAINTENANCE AND FRAUD MITIGATION TOOL

(71) Applicant: Accenture Global Solutions Limited, Dublin 4 (IE)

(72) Inventors: Pamala Ann Rhoads, Ocean City, MD (US); Krishnendu Chandra, Dunwoody, GA (US); Mohit Sharma, Bangalore (IN); Namitha Pishe, Bangalore (IN); Bolaka Mukherjee, Howrah (IN); Ankur Garg, Gurgaon (IN); Dhulappa Rajole, Bidar (IN); Suresh Rao Puneeth, Bangalore (IN); Kishore Babu Nandanamudi, Flower Mound, TX (US)

(21) Appl. No.: 17/315,123

(22) Filed: May 7, 2021

(30) Foreign Application Priority Data
Mar. 23, 2021 (IN) 202141012538

(51) Int. Cl. G06Q 30/00; G06N 20/00

(52) U.S. Cl. CPC G06Q 30/0185; G06N 20/00

(57) ABSTRACT

Aspects of the present disclosure provide systems, methods, and computer-readable storage media that support automated account maintenance and fraud mitigation for secure accounts such as vendor master accounts or client master accounts. To illustrate, a system receives a request from a user to update an account. The system extracts request data from the request, for example using natural language processing and optical character recognition. The system performs validation operation(s) (e.g., entry validation, location validation, domain validation, etc.), in some implementations using one or more machine learning models. Upon successful validation, if the user is an authorized contact for the account, the system authenticates the request (e.g., via request of an authorization code) and updates the account. If the user is not an authorized contact, the system transmits authentication requests to the authorized contact(s) and, based on receipt of responses from the authorized contact(s), the system updates the account.

### CROSS-REFERENCE TO RELATED APPLICATION

The present application claims priority to Indian Provisional Patent Application No. 202141012538 filed Mar. 23, 2021 and entitled “ACCOUNT MAINTENANCE AUTHENTICATION AND FRAUD MITIGATION,” the disclosure of which is incorporated by reference herein in its entirety.

### TECHNICAL FIELD

The present disclosure relates generally to systems and methods for supporting secure and automated account maintenance and fraud mitigation based on authenticated communications in substantially real-time.

### BACKGROUND

Advances in technology have led to advancement in record keeping and account maintenance by businesses and other entities. For example, instead of relying on paper records, most entities have transitioned to using computerized records that are stored in local databases (e.g., within servers or other devices in possession of an entity) or in external databases, such as cloud-based storage solutions. Using computerized or electronic records increases efficiency of an entity, such as a manufacturer that maintains accounts for various vendors and clients, by increasing the speed with which the entity is able to pay bills, submit invoices, update information, and the like.

One drawback of electronic account maintenance is that the entity is exposed to another source of fraud. In particular, fraudulently submitted invoices or account changes submitted on behalf of vendors, referred to as “Vendor Master Fraud,” has been estimated to cost companies upward of $26 billion since 2016. As an example of Vendor Master Fraud, a malicious entity may electronically submit an invoice for payment to an entity that appears to be from a legitimate vendor, but the invoice includes a bank account of the malicious entity. As another example, a malicious entity may send an email to the entity posing as a vendor and requesting to change a contact name, payment address, or bank account, often with a false sense of urgency or even with fake documents attached. In order to combat this rampant fraud, many entities implement a largely manual process for maintaining secure accounts, such as vendor and client accounts. To illustrate, invoices, payment requests, and account changes are often reviewed and approved by one or more human operators, sometimes requiring the human operator to contact the requesting party to confirm their request. These processes are time consuming and inefficient, leading to many master accounts being updated periodically, instead of in real-time, and resulting in frustrated vendors and clients who have to request an account change and then wait to be contacted to confirm the request they already sent. Thus, companies implementing secure accounts electronically face a tradeoff between responsiveness and risk of fraud, in addition to incurring the costs associated with human operators.

### SUMMARY

Aspects of the present disclosure provide systems, methods, apparatus, and computer-readable storage media that support secure account maintenance and fraud mitigation. As described herein, account maintenance (e.g., creation, updating, or deletion) may initiated based on successful validation of a request from a user and based on authentication from the user or from one or more approved contacts that correspond to an entity associated with the account. In order to validate the request, request data may be extracted from the request using natural language processing (NLP), optical character recognition (OCR), machine learning, or a combination thereof, to extract the request data to be validated. The validation may include validating information included in the request, information associated with the user from which the request is received, other information, or a combination thereof. In some implementations, one or more machine learning (ML) models may be trained to generate a fraud score based on account-related requests (and optionally information associated with the users from which the requests are received), and the fraud score may be compared to one or more thresholds as part of the validation. Upon validation of the request, if the user is not one of the approved contact(s), authentication request(s) are sent to the approved contact(s), and the account may be updated based on receipt of a respective authentication response from each of the approved contact(s). Alternatively, if the user is an approved contact, the account may be updated based on receipt of an authentication code from the user. Because a fraudulent request (e.g., a request sent from a malicious entity or from a user that unknowingly has their device hijacked) undergoes both validation and authentication by approved contact(s) before an account is updated, security of the accounts is maintained without requiring manual input from the account maintenance side. Thus, the systems, methods, devices, and computer-readable media of the present disclosure support real-time, automated, and secure account maintenance and reduce or otherwise mitigate fraud through the validation and authentication of requests, as compared to other account maintenance systems.

In a particular aspect, a method for automated account maintenance and fraud mitigation includes receiving, by one or more processors, a request from a first user. The request is to update an account corresponding to an entity. The method also includes extracting, by the one or more processors, request data from the request. The request data indicates at least an entity identifier corresponding to the entity and a particular update to be performed on the account. The method includes performing, by the one or more processors, one or more validation operations based on the request data. The method also includes comparing, by the one or more processors, the first user to one or more approved contacts corresponding to the entity based on success of the one or more validation operations. The method includes initiating, by the one or more processors, transmission of one or more authentication requests to the one or more approved contacts based on the first user failing to match the one or more approved contacts. The method further includes updating, by the one or more processors, the account according to the particular update based on receipt of an authentication response from each of the one or more approved contacts.

In another particular aspect, a device for automated account maintenance and fraud mitigation includes a memory and one or more processors communicatively coupled to the memory. The one or more processors are configured to receive a request from a first user. The request is to update an account corresponding to an entity. The one or more processors are also configured to extract request data from the request. The request data indicates at least an entity identifier corresponding to the entity and a particular update to be performed on the account. The one or more processors are configured to perform one or more validation operations based on the request data. The one or more processors are also configured to compare the first user to one or more approved contacts corresponding to the entity based on success of the one or more validation operations. The one or more processors are configured to initiate transmission of one or more authentication requests to the one or more approved contacts based on the first user failing to match the one or more approved contacts. The one or more processors are further configured to update the account according to the particular update based on receipt of an authentication response from each of the one or more approved contacts.

In another particular aspect, a non-transitory computer-readable storage medium stores instructions that, when executed by one or more processors, cause the one or more processors to perform operations for automated account maintenance and fraud mitigation. The operations include receiving a request from a first user. The request is to update an account corresponding to an entity. The operations also include extracting request data from the request. The request data indicates at least an entity identifier corresponding to the entity and a particular update to be performed on the account. The operations include performing one or more validation operations based on the request data. The operations also include comparing the first user to one or more approved contacts corresponding to the entity based on success of the one or more validation operations. The operations include initiating transmission of one or more authentication requests to the one or more approved contacts based on the first user failing to match the one or more approved contacts. The operations further include updating the account according to the particular update based on receipt of an authentication response from each of the one or more approved contacts.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an example of a system that supports automated account maintenance and fraud mitigation according to one or more aspects;

FIG. 2 is a block diagram of another example of a system that supports automated account maintenance and fraud mitigation according to one or more aspects;

FIG. 3 is a flow diagram illustrating an example of a method for automated account maintenance and fraud mitigation according to one or more aspects;

FIG. 4 shows an example of extracting information from a request for use in automated account maintenance according to one or more aspects;

FIGS. 5A-C are diagrams of examples of machine learning and deep learning models configured to validate requests according to one or more aspects;

FIG. 6 is a block diagram of an example of a cloud-based implementation of a system that supports automated account maintenance and fraud mitigation according to one or more aspects; and

FIG. 7 is a flow diagram illustrating another example of a method for automated account maintenance and fraud mitigation according to one or more aspects.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

### DETAILED DESCRIPTION

Aspects of the present disclosure provide systems, methods, apparatus, and computer-readable storage media that support secure, automated account maintenance and fraud mitigation, such as for vendor and client master accounts. To illustrate, the techniques described herein may combine vendor file information and authentication technology with automated vendor processes in an account maintenance system that mitigates an entity's fraud exposure by authenticating account requests without requiring a human operator. In some implementations, the account maintenance system may leverage artificial intelligence and machine learning to generate a risk score for an account request (or for existing account data), and the risk score may be used to perform fraud mitigation operation(s). Additionally, based on the fraud score and/or an identity of a requestor, account requests may be authenticated via secure communications with approved contacts for respective accounts, which are automatically performed by the account maintenance system. In this manner, the present disclosure supports real-time vendor master account and client master account updates and maintenance with no (or minimal) user input while also reducing exposure to fraudulent account changes or payment requests.

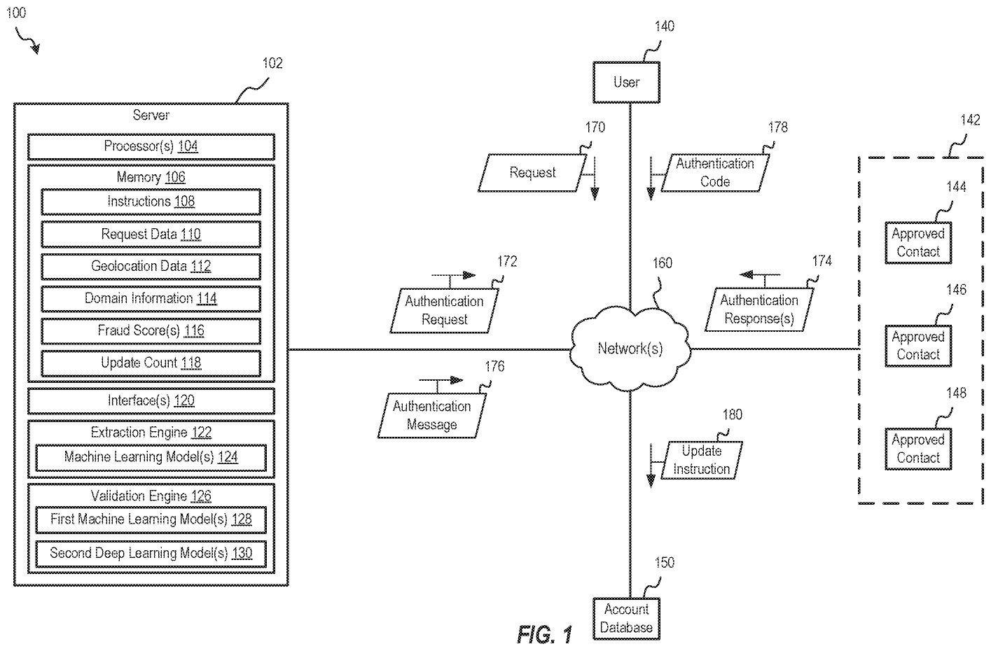

Referring to FIG. 1, an example of a system that supports automated account maintenance and fraud mitigation according to one or more aspects is shown as a system 100. The system 100 may be configured to validate and authenticate requests to add, delete, or update secure accounts, such as vendor accounts, client accounts, or the like, with improved efficiency and reduced exposure to fraud as compared to other secure account maintenance systems. As shown in FIG. 1, the system 100 includes a server 102, a user 140 (e.g., a user device), one or more approved contacts 142 (e.g., one or more approved contact devices), an account database 150, and one or more networks 160. In some implementations, the approved contacts 142 include a first approved contact 144 (e.g., a first approved contact device), a second approved contact 146 (e.g., a second approved contact device), and a third approved contact 148 (e.g., a third approved contact device). Alternatively, the approved contacts 142 may include more than three or fewer than three approved contacts (e.g., approved contact devices). In some implementations, one or more of the user 140, the first approved contact 144, the second approved contact 146, the third approved contact 148, or the account database 150 may be optional, or the system 100 may include additional components, such as one or more external systems configured to support geolocation services, domain searching services, machine learning and artificial intelligence training and implementation, natural language processing services, or optical character recognition services, as non-limiting examples.

The server 102 (e.g., an account management device) may include or correspond to a server or another type of computing device, such as a desktop computing device, a laptop computing device, a personal computing device, a tablet computing device, a mobile device (e.g., a smart phone, a tablet, a personal digital assistant (PDA), a wearable device, and the like), a virtual reality (VR) device, an augmented reality (AR) device, an extended reality (XR) device, a vehicle (or a component thereof), an entertainment system, other computing devices, or a combination thereof, as non-limiting examples. The server 102 includes one or more processors 104, a memory 106, one or more communication interfaces 120, an extraction engine 122, and a validation engine 126. In some other implementations, one or more of the extraction engine 122 or the validation engine 126 may be optional, one or more additional components may be included in the server 102, or both. Additionally or alternatively, one or more of the extraction engine 122 and the validation engine 126 may be integrated in the one or more processors 104 or may be implemented by instructions, modules, or logic stored in the memory 106. It is noted that functionalities described with reference to the server 102 are provided for purposes of illustration, rather than by way of limitation and that the exemplary functionalities described herein may be provided via other types of computing resource deployments. For example, in some implementations, computing resources and functionality described in connection with the server 102 may be provided in a distributed system using multiple servers or other computing devices, or in a cloud-based system using computing resources and functionality provided by a cloud-based environment that is accessible over a network, such as the one of the one or more networks 160. To illustrate, one or more operations described herein with reference to the server 102 may be performed by one or more servers or a cloud-based system that communicates with one or more client or user devices.

The one or more processors 104 may include one or more microcontrollers, application specific integrated circuits (ASICs), field programmable gate arrays (FPGAs), central processing units (CPUs) having one or more processing cores, or other circuitry and logic configured to facilitate the operations of the server 102 in accordance with aspects of the present disclosure. The memory 106 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. Software configured to facilitate operations and functionality of the server 102 may be stored in the memory 106 as instructions 108 that, when executed by the one or more processors 104, cause the one or more processors 104 to perform the operations described herein with respect to the server 102, as described in more detail below. Additionally, the memory 106 may be configured to store data and information, such as request data 110, geolocation data 112, domain information 114, one or more fraud scores 116, and an update count 118. Illustrative aspects of the request data 110, the geolocation data 112, the domain information 114, the fraud scores 116, and the update count 118 are described in more detail below.

The one or more communication interfaces 120 may be configured to communicatively couple the server 102 to the one or more networks 160 via wired or wireless communication links established according to one or more communication protocols or standards (e.g., an Ethernet protocol, a transmission control protocol/internet protocol (TCP/IP), an Institute of Electrical and Electronics Engineers (IEEE) 802.11 protocol, an IEEE 802.16 protocol, a 3rd Generation (3G) communication standard, a 4th Generation (4G)/long term evolution (LTE) communication standard, a 5th Generation (5G) communication standard, and the like). In some implementations, the server 102 includes one or more input/output (I/O) devices that include one or more display devices, a keyboard, a stylus, one or more touchscreens, a mouse, a trackpad, a microphone, a camera, one or more speakers, haptic feedback devices, or other types of devices that enable a user to receive information from or provide information to the server 102. In some implementations, the server 102 is coupled to the display device, such as a monitor, a display (e.g., a liquid crystal display (LCD) or the like), a touch screen, a projector, a virtual reality (VR) display, an augmented reality (AR) display, an extended reality (XR) display, or the like. In some other implementations, the display device is included in or integrated in the server 102.

The extraction engine 122 is configured to extract information from requests received by the server 102. For example, the server 102 may receive one or more requests to update an account, such as a vendor master account or client master account, that is maintained by the server 102, and the extraction engine 122 is configured to extract information from the one or more requests. To further illustrate, the requests may be emails, and the extraction engine 122 may be configured to perform natural language processing (NLP) on the emails to extract information from the emails. As another example, if the emails include images, the extraction engine 122 may be configured to perform optical character recognition (OCR) on the images to extract text from the images and to perform NLP on the extracted text to extract the information from the requests. As another example, the requests may be text messages (e.g., short messaging service (SMS) messages), and the extraction engine 122 may be configured to perform NLP on the text messages to extract the information. As another example, the requests may be phone calls or other audio requests, and the extraction engine 122 may be configured to perform speech to text conversion and NLP to extract the information. In some implementations, the extraction engine 122 may include, or have access to, a set of one or more machine learning (ML) models 124 that are configured to perform one or more operations described herein with reference to the extraction engine 122. As a non-limiting example, the set of ML models 124 may be configured to identify regions for performing OCR on input images, as further described below. As another non-limiting example, the set of ML models 124 may be configured to extract information from text data of requests, as further described below.

The validation engine 126 is configured to validate requests received by the server 102 to update accounts maintained by the server 102. For example, the requests may include emails, text messages (e.g., SMS messages), phone calls or other audio messages, or the like, and the validation engine 126 is configured to determine whether the request is properly received and in conformance with rules or policies associated with a respective account, in addition to whether one or more approved contacts sign off on the request. The validation engine 126 may be configured to perform multiple types of validation operations, such as validation based on characteristics of a user that issues the request, validation based on information from one or more external data sources or systems, validation based on communication with one or more contacts associated with an account for which the request is issued, or a combination thereof, as further described below. In some implementations, the validation engine 126 may include, or have access to, a first set of one or more ML models 128, a second set of one or more deep learning (DL) models 130, or both. The first set of ML models 128 may be configured to perform a first set of validation operations and the second set of DL models 130 may be configured to perform a second set of validation operations, and outputs of the first set of ML models 128 and the second set of DL models 130 may be ensembled to generate a validation output, as further described below.

In some implementations, each of the sets of ML models 124, 128, and 130 may be implemented as one or more neural networks (NNs). In some other implementations, the sets of ML models 124, 128, and 130 may be implemented as other types of ML models or constructs, such as support vector machines (SVMs), decision trees, random forests, regression models, Bayesian networks (BNs), dynamic Bayesian networks (DBNs), naive Bayes (NB) models, Gaussian processes, hidden Markov models (HMMs), regression models, and the like. Although shown in FIG. 1 as being included in the engines 122 and 126, the sets of ML models 124, 128, and 130 may be stored in the memory 106 and executed by the respective engine (or the processor 104) to perform the functionality described herein. In some other implementations, one or more of the sets of ML models 124, 128, and 130 may be stored and executed at an external device, such as a device in the cloud, and the server 102 may provide input data to and receive output data from the external device to enable performance of the functionality described herein. Alternatively, the sets of ML models 124, 128, and 130 may be trained at one or more external devices, and parameters indicative of the trained ML models may be provided to the server 102 for executing the trained ML models at the server 102.

The user 140 (e.g., the user device) may be any entity that communicates request(s) to the server 102 to add, delete, or update an account maintained by the server 102. For example, the user 140 may include legitimate users, such as vendors or clients that make proper requests to update their respective accounts to an entity, such as a manufacturer, for which the server 102 maintains secure, private accounts such as vendor master accounts, client master accounts, and the like. As another example, the entity may include a service provider, a software provider, a network application provider, or the like, and the accounts may include user accounts, customer accounts, and the like. As yet another example, the entity may include a bank or other financial service provider, and the secure accounts may include client accounts, stock accounts, investment accounts, and the like. Although some requests may be provided by legitimate users, other requests may be fraudulently provided by malicious entities, such as scammers, or may be provided by legitimate users without their knowledge, such as by the legitimate user being “hacked” or an improper request being provided by a negligent or disgruntled employee. As such, to reduce fraudulent changes to the secure accounts, such as changing of payment addresses, adding of improper authorized accounts, submission of fraudulent invoices, and the like, requests from all users, including the user 140, are validated by the server 102.

The approved contacts 142 (e.g., the approved contact devices) represent one or more approved contacts that correspond to a particular account maintained by the server 102. For example, a particular vendor for which an account is maintained by the server 102 may indicate that any account update associated with payment or distribution of funds, or account control, is to be confirmed by any, or all, of the first approved contact 144 (e.g., an executive officer), the second approved contact 146 (e.g., a financial officer), or the third approved contact 148 (e.g., an operating officer). In some implementations, the approved contacts 142 may be tiered or hierarchically organized in order of contact. For example, the second approved contact 146 may be contacted if no response is received from the first approved contact 144, and the third approved contact 148 may be contacted if no response is received from the second approved contact 146. Although three approved contacts 144-148 are shown in FIG. 1, in other implementations, the approved contacts 142 may include fewer than three or more than three contacts.

The account database 150 may be configured to store the various secure accounts maintained by the server 102. For example, the account database 150 may include or correspond to one or more secure databases located onsite with the server 102 or remotely, such as in the cloud, and configured to modify the stored accounts only upon instructions from the server 102. The account database 150 may be configured to store various information for each account. As a non-limiting example, the account database 150 may be configured to store vendor master accounts that include a vendor name, a mailing address, a phone number, one or more working contacts, one or more approved contacts, one or more bank accounts for receiving payments, one or more bank accounts for withdrawing funds, one or more goods or services provided by the vendor, one or more account balances, an update count, update timestamps and information, one or more rules or policies, and the like.

During operation of the system 100, the server 102 may receive a request 170 from the user 140 to update a particular account, such as a vendor master account, maintained by the server 102. For example, the request 170 may include or correspond to an email, a text message (e.g., an SMS message), a phone call or other audio message, or the like, and the request 170 may indicate a modification or action to take with respect to the account, such as adding an approved contact, changing a mailing address or a payment address, changing a financial account, requesting payment of an invoice, or the like. The server 102 may be configured to receive and process requests from a variety of users, instead of only approved contacts, to reduce a burden on vendors or clients of the entity for which the server 102 maintains secure accounts. Because requests may be issued by many different users, the server 102 is configured to validate any request of “significant importance,” such as requests to change as aspect of an account associated with payments or credits, security procedures, and the like, or any request that is defined as requiring validation or authorization.

The server 102 may receive the request 170 from the user 140 via the networks 160 and provide the request 170 to the extraction engine 122. The extraction engine 122 may perform one or more operations to extract the request data 110 from the request 170. The request data 110 may include an account identifier of an account corresponding to the request 170, a user identifier of the user 140, an entity identifier of an entity associated with the account, a requested operation to be performed with respect to the account, a password or other security information associated with the account, a date or time by which the requested operation is to be performed, updated account information to add to (or replace current information stored in) the account, other information, or a combination thereof. The extraction engine 122 may extract the request data 110 by performing one or more NLP operations, one or more OCR operations, one or more speech to text conversion operations, other operations, or a combination thereof.

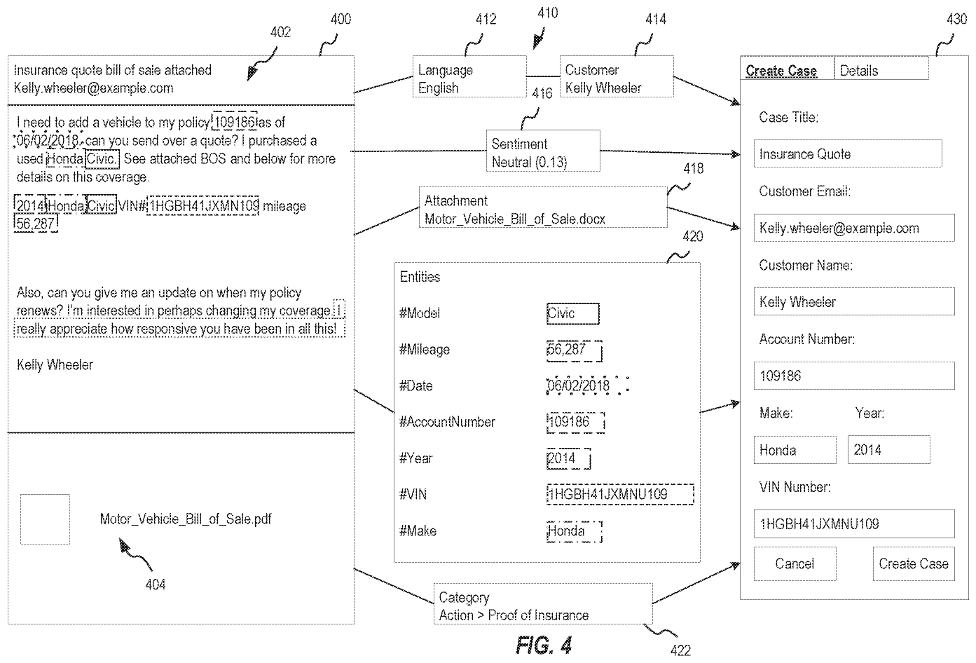

In some implementations, the operations performed by the extraction engine 122 are selected based on a type of the request 170. To illustrate, if the request 170 is an email that includes text and not images or attachments with different file formats, or the request includes a text message, the extraction engine 122 may perform one or more NLP operations on the text to extract the request data 110. The one or more NLP operations may include segmentation operations, tokenization operations, text cleaning operations, vectorization operations, bag of words processing, term frequency and inverse document frequency (TF-IDF) operations, feature extraction and engineering operations, lemmatization operations, stemming operations, normalization operations, word embedding operations, other NLP operations, or a combination thereof. The extraction engine 122 may perform the NLP operations to identify a topic of the request 170, one or more named entities included in the request 170, values corresponding to the named entities, requested updates or instructions, and the like, in order to extract (e.g., generate) the request data 110. In some implementations, the set of ML models 124 may be trained to extract keywords, values, and/or phrases from the text data, as further described herein with reference to FIG. 4. If the request 170 is an audio request, the extraction engine 122 may perform one or more speech to text conversion operations, such as automatic speech recognition (ASR), on the audio request to generate text data, then perform one or more of the above-described NLP operations on the text data to extract the request data 110.

If the request 170 includes images or attachments having particular non-text formats, such as portable document format (PDF) files or other format files without separate text data, the extraction engine 122 may perform one or more OCR operations to convert the image or other format file to text data, then perform one or more of the above-described NLP operations on the text data to extract the request data 110. In some implementations, the extraction engine 122 may provide the request 170 as input data to the set of ML models 124 to identify regions in the request 170 (e.g., in an image, in a PDF file, etc.) to perform the one or more OCR operations. The set of ML models 124 may be trained to recognize what regions are expected to include text, such as providing labeled training data that includes multiple images or other input files with labeled text regions, labeled document types, labeled vendors, clients, or users, or the like. The regions in the request 170 identified by the set of ML models 124 may be used to perform OCR operations, followed by NLP operations, to extract (e.g., generate) the request data 110.

After the request data 110 is extracted from the request 170, the validation engine 126 may perform one or more validation operations based on the request data 110. The validation operations may include operations to validate the user 140, the request 170, related characteristics, other information, or a combination thereof. As non-limiting examples, the validation operations may include validating an identity of the user 140, validating a location of the user 140, validating a domain associated with the user 140, validating a form or format of the request 170, validating a frequency of the request 170, other validation operations, or a combination thereof. In some implementations, the validation engine 126 may perform multiple validation operations, and validation may be determined to be successful if each validation operation is successful, or if a threshold number of validation operations are successful. Validation may also depend on the fraud scores 116, as further described below.

In some implementations, the validation operations include comparing an entity identifier included in the request data 110 and an account identifier included in the request data 110 to account data from the account database 150 for the account associated with the request 170. For example, the validation engine 126 may compare the entity identifier included in the request data 110 to an entity identifier included in the account at the account database 150 that is indicated by the account identifier included in the request data 110. If the entity identifiers match, the validation operation is successful. If the entity identifiers do not match, or if the account identifier included in the request data 110 does not match any account identifier for accounts stored at the account database 150, the validation operation fails.

In some implementations, the validation operations include verifying a location of the user 140. To illustrate, the validation engine 126 may obtain geolocation data 112 that indicates location information that corresponds to the user 140. For example, the geolocation data 112 may include longitude coordinates, latitude coordinates, an address (e.g., a street address, a city, a state, a county, a country, etc.), or the like, that corresponds to a location of the user 140. The validation engine 126 may access an external geolocation service system, such as a global positioning system (GPS) satellite or other geolocation server to receive the geolocation data 112. Additionally or alternatively, the validation engine 126 may determine the geolocation data 112 based on the request data 110 (e.g., based on an internet protocol (IP) address and domain name lookup, based on geolocation data included in the request, or the like). The validation engine 126 may compare the geolocation data 112 to geolocation data that corresponds to the account associated with the request. For example, each account stored at the account database 150 may include location data associated with a respective entity of the account, and the validation engine 126 may compare the geolocation data 112 to the location data that corresponds to the account associated with the request 170. If the geolocation data 112 matches the location data, the validation operation is successful. If the geolocation data 112 does not match the location data, the validation operation fails. Additionally or alternatively, the validation engine 126 may determine whether the geolocation data 112 matches any restricted locations. For example, the server 102 may maintain a list of restricted locations, such as locations associated with known malicious entities or frequent occurrences of fraud, or locations associated with direct competitors of the entity indicated in the request data 110. If the geolocation data 112 matches any of the restricted locations in the list, the validation operation fails.

In some implementations, the validation operations include verifying a domain of the user 140. To illustrate, the validation engine 126 may obtain domain information 114 that identifies a domain from which the user 140 sends the request 170. For example, the domain information 114 may indicate a domain name, an IP address, or the like, that corresponds to the user 140. In some implementations, the validation engine 126 may provide the domain name or IP address to a domain registry to obtain registration information, such as an entity name, an address, geolocation data, or that like, that corresponds to the domain of the user 140 and is included in the domain information 114. The validation engine 126 may access an external domain registry service to receive the domain information 114. Additionally or alternatively, some or all of the domain information 114 may be extracted from the request 170. The validation engine 126 may compare the domain information 114 to a domain name (or IP address) that corresponds to the entity associated with the account indicated in the request 170. If the domain information 114 matches the stored domain name (or other domain information), the validation operation is successful. If the domain information 114 does not match the stored domain name (or other domain information), the validation operation fails. In implementations in which the domain information 114 includes registration information, the registration information may be compared to information associated with the entity and stored in the account database 150, such as the entity name, the address, location data, or the like, and if the registration information matches the stored information, the validation operation is successful. Additionally or alternatively, the validation engine 126 may determine whether the domain information 114 matches any restricted domains or entities. For example, the server 102 may maintain a list of restricted domains or entities, such as domains associated with known malicious entities or frequent occurrences of fraud, known malicious entities, direct competitors of the entity associated with the account, or the like. If the domain information 114 matches any of the restricted domains or entities in the list, the validation operation fails.

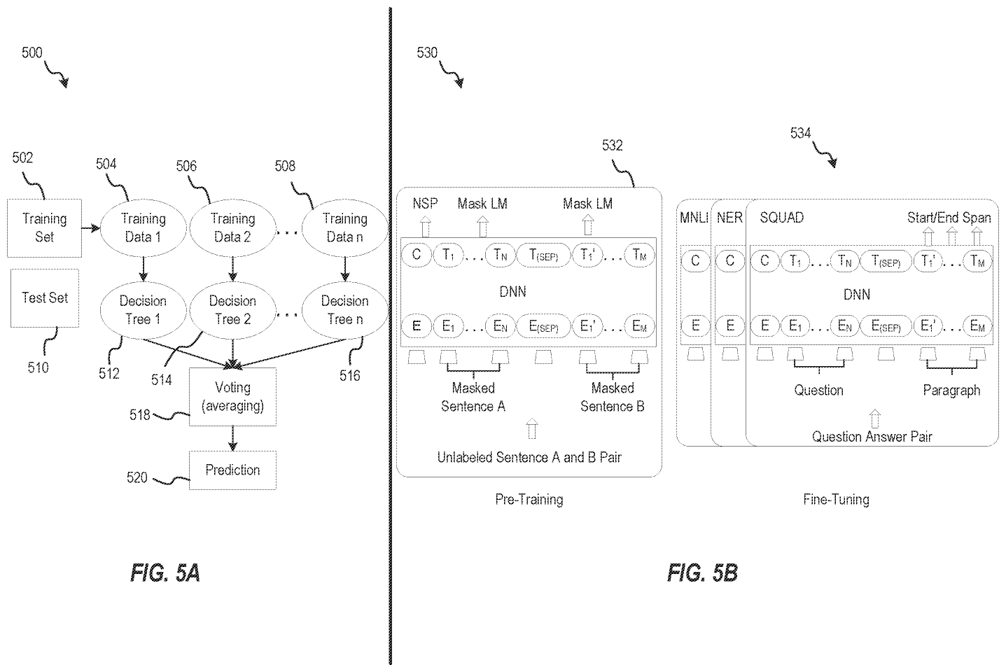

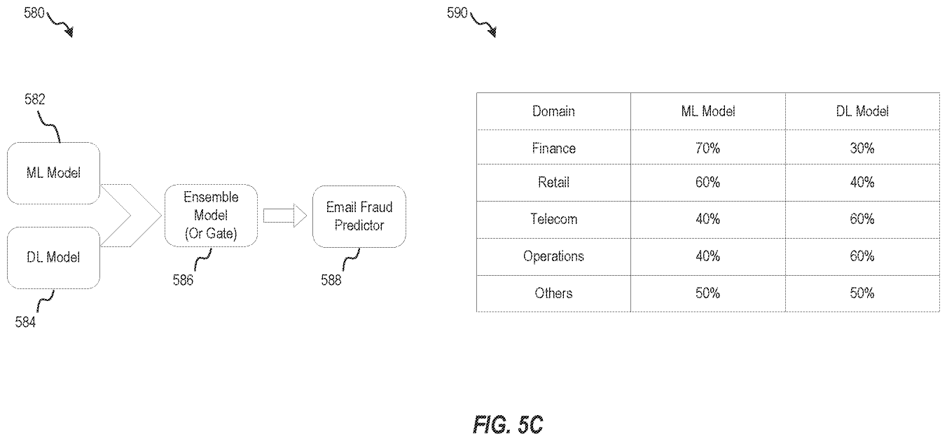

Additionally or alternatively to performing the validation operations, the validation engine 126 may generate the fraud scores 116 based on the request 170 (e.g., based on the request data 110, and optionally the geolocation data 112 and/or the domain information 114, or other information). For example, the fraud scores 116 may be based on a number of successful validation operations, based on a set of fraud score rules, or the like. In some implementations, the validation engine 126 may provide the request data 110 (and optionally the geolocation data 112 and/or the domain information 114) as input data to the first set of ML models 128, the second set of DL models 130, or both, to generate the fraud scores 116. The first set of ML models 128 may include one or more ML models that are trained to generate a fraud score for input request data using machine learning, and the second set of DL models 130 may include one or more DL models that are trained to generate a fraud score for input request data using deep learning. The first set of ML models 128 and the second set of DL models 130 may be trained using multiple labeled requests (e.g., labeled as fraudulent or legitimate) to output respective fraud scores that indicate a predicted likelihood that an input request is fraudulent (or legitimate). In some implementations in which both the first set of ML models 128 and the second set of DL models 130 are used, the fraud scores 116 may be ensembled to generate a final fraud score. For example, the fraud scores 116 may be ensembled by averaging, weighted averaging, or other ensembling techniques. Additional details of using ML models and DL models to determine fraud scores are described further herein with reference to FIGS. 5A-C.

In some implementations, the validation engine 126 may block requests to update an account if the account has been updated too often during a monitoring period, or if the account has been associated with too many blocked requests (e.g., requests that are flagged as fraudulent) during the monitoring time period. To illustrate, the server 102 may maintain a respective update count 118 for each account in the account database 150. The update count 118 may indicate a number of updates to the account during a particular time period (e.g., a monitoring period), such as one day, one week, or one month, as non-limiting examples. As part of validating the request 170, the validation engine 126 may compare the update count 118 associated with the account indicated by the request 170 to a threshold. If the update count 118 is greater than or equal to the threshold, a validation operation fails, or the validation engine 126 otherwise flags the request 170 as potentially fraudulent. If the update count 118 is less than the threshold, the update count 118 is incremented based on the request 170 (regardless of whether the request 170 is validated or not). Although described as part of validation, in other implementation, the server 102 may block or flag requests, after validation, if the update count 118 is not less than the threshold (e.g., before updating the account).

If validation fails (e.g., if one or a threshold number of validation operations fail, if the fraud scores 116 fail to satisfy a threshold, or another metric for validation failure), the validation engine 126 may initiate performance of one or more fraud detection or prevention operations. For example, the fraud detection or prevention operations may include additional authorization checks, quarantining the request 170 for manual evaluation, notifying the approved contacts 142, increasing an exposure level associated with the account, locking the account from updates until a fraud detection process is completed, other operations, or a combination thereof. As a particular, non-limiting example, each account may be assigned a fraud exposure level, such as low, medium, or high, and some updates may be performed only if the exposure level satisfies a related threshold. To illustrate, accounts having the high exposure level may be locked from any updates, accounts having the medium exposure level may be allowed to be updated if the update does not change any financial information (e.g., a bank account, a billing or payment address, etc.) or approved contacts, and accounts having the low exposure level may have no restrictions on updates.

Upon successful validation of the request 170 by the validation engine 126, the validation engine 126 (or the processor 104) may compare the user 140 to the approved contacts 142 that correspond to the account indicated in the request 170 to determine one or more authentication communications to perform. If the user 140 is not one of the approved contacts 142, the server 102 may send an authentication request 172 to the approved contacts 142 to authenticate the requested update. The authentication request 172 may include or indicate information that enables the approved contacts 142 to determine whether the request 170 should be authorized, such as the requested update to be performed, the account to be updated, the information to be updated, identification of the user 140, other information, or a combination thereof. In some implementations, the authentication request 172 includes or indicates a number of updates during a threshold time period (e.g., the update count 118), a number of blocked requests or requests flagged as potentially fraudulent during the threshold time period, the fraud scores 116, or a combination thereof. The server 102 may send the authentication request 172 to any or all of the approved contacts 142 concurrently, or the server 102 may selectively send the authentication request 172 to the approved contacts 142 in a particular order. As an example, the server 102 may transmit the authentication request 172 to each of the first approved contact 144, the second approved contact 146, and the third approved contact 148 for authentication by one or more of the approved contacts 142. As another example, the first approved contact 144 may be a primary approved contact, the second approved contact 146 may be a secondary approved contact, and the third approved contact 148 may be a tertiary approved contact. In this example, the server 102 first sends the authentication request 172 to the first approved contact 144. If no response is received within a threshold time period from the first approved contact 144, the server 102 then sends the authentication request 172 to the second approved contact 146. If no response is received within a threshold time period from the second approved contact 146, the server 102 then sends the authentication request 172 to the third approved contact 148.

The server 102 may receive one or more authentication responses 174 from the approved contacts 142. For example, the authentication responses 174 may include a first authentication response from the first approved contact 144, a second authentication response from the second approved contact 146, and a third authentication response from the third approved contact 148, if each of the approved contacts 144-148 respond to the authentication request 172. The authentication responses 174 may indicate authentication (e.g., approval) or rejection of the update indicated by the request 170. Alternatively, if an approved contact rejects the update, no response may be sent. In some implementations, the authentication request and response process may be performed using an authentication code, such as a code generated in accordance with 2-factor or other multi-factor authentication. The server 102 may determine whether to update the account based on receipt of the authentication responses 174. As an example, the server 102 may determine to update the account if at least one of the approved contacts 142 provides the authentication responses 174 (and the update is approved by the respective approved contact(s)). As another example, the server 102 may determine to update the account if all of the approved contacts 142 to which the authentication request 172 is sent provide the authentication responses 174 (and the update is approved by the approved contacts 142). As another example, the server 102 may determine to update the account if a threshold number of the approved contacts 142 provide the authentication responses 174 (and the update is approved by the respective approved contacts). The threshold number may be one, two, three, four, or any number of approved contacts, and the threshold number may be stored in the account at the account database 150, such that each account may have a different threshold number of required authentication responses. If the server 102 does not receive any (or the threshold number of) authentication responses 174, the server 102 may determine not to update the account. In some implementations, in response to determining not to update the account, the server 102 may initiate one or more of the above-described fraud detection or prevention operations.

Alternatively, if the user 140 is one of the approved contacts 142, the server 102 may send an authentication message 176 to the user 140 upon successful validation by the validation engine 126. The authentication message 176 may include may include or indicate information that enables the user 140 to determine whether the request 170 should be authorized, such as the requested update to be performed, the account to be updated, the information to be updated, other information, or a combination thereof. In some implementations, the authentication message 176 includes or indicates a number of updates during a threshold time period (e.g., the update count 118), a number of blocked requests or requests flagged as potentially fraudulent during the threshold time period, the fraud scores 116, or a combination thereof. The authentication message 176 also includes a prompt for an authentication code. The authentication code may be distributed to the user 140 upon the user 140 being named as an approved contact for the account. Alternatively, the authentication code requested by the server 102 may correspond to an authentication code generated by a randomized, time-based authentication code generator that is accessible to the user 140 and can be verified by the server 102. For example, the authentication code may be requested using 2-factor or other multi-factor authentication techniques.

Responsive to receiving the authentication message 176, the user 140 may send an authentication code 178 to the server 102. If the authentication code 178 received from the user 140 matches a corresponding authentication code stored at the server 102 (or at the account database 150) for the corresponding account or otherwise generated by the server 102 (e.g., using 2-factor or other multi-factor authentication techniques) to verify the authentication code 178, the server 102 may determine to update the account. If the authentication code 178 received from the user 140 does not match the authentication code at the server 102, or if no authentication code is received, the server 102 may determine not to update the account. In some implementations, in response to determining not to update the account, the server 102 may initiate one or more of the above-described fraud detection or prevention operations.

Upon determining to update the account, the server 102 may initiate the update indicated by the request 170 at the account database 150. Updating the account may include the server 102 sending an update instruction 180 to the account database 150. The update instruction 180 may cause performance of the requested update to the account at the account database 150. For example, the update instruction 180 may cause creation of a new account, deletion of the account, a change address for the account, a change of bank account for the account, a change of an approved contact (e.g., adding a new approved contact, replacing an existing approved contact, etc.), submission of an invoice for payment, or the like. In some implementations, the update instruction 180 may be encrypted to prevent unauthorized devices from accessing the update instruction 180.

As described above, the system 100 supports secure account maintenance and fraud mitigation for accounts stored at the account database 150, such as vendor master accounts, client master accounts, or the like. Because a fraudulent request (e.g., a request sent from a malicious entity or from a user that unknowingly has their device hijacked) undergoes both validation by the validation engine 126 and authentication by the approved contacts 142 (or the user 140 if the user 140 is an approved contact) before an account is updated based on the request 170, security of the accounts is maintained without requiring manual input at the server 102 or manual inspection of the request. Thus, the system 100 balances competing goals of automating and reducing the time to execute updates to secure accounts in addition to reducing or preventing fraudulent updates to the accounts. This balance is maintained by leveraging artificial intelligence and machine learning to automatically validate requests based on a variety of factors, such as included information, geolocation data, domain names, monitored responses over time, and the like, in addition to automating communications with approved contacts to authenticate account updates. As such, the system 100 supports real-time/substantially real-time (e.g., accounting for processing needs of the various aspects being utilized and the responses received from the approved contacts), automated, and secure account maintenance and reduces or otherwise mitigates fraud, as compared to other account maintenance systems. The system 100 may be built using a service oriented architecture that enables the system 100 to be extended to leverage other fraud prevention systems, such as external anti-fraud intelligence networks or other systems.

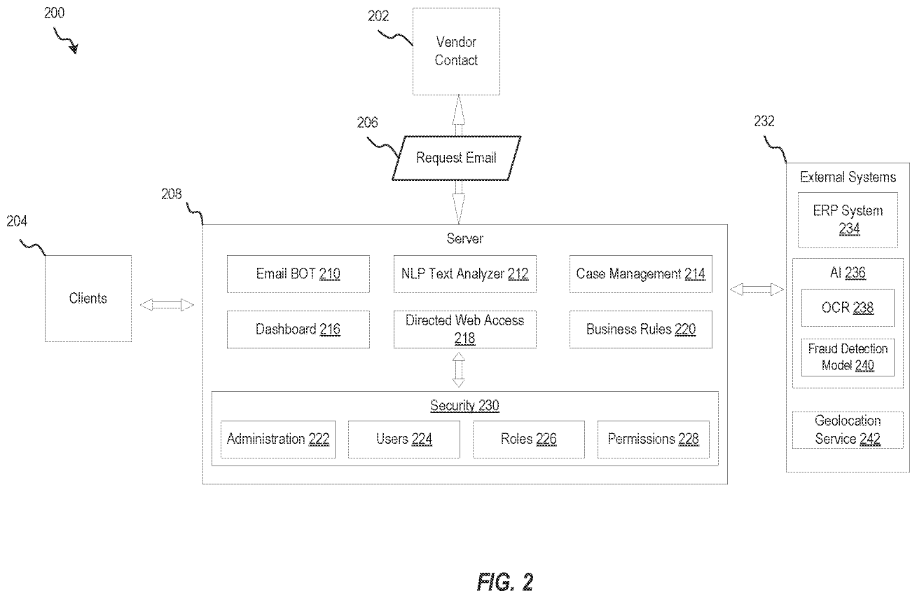

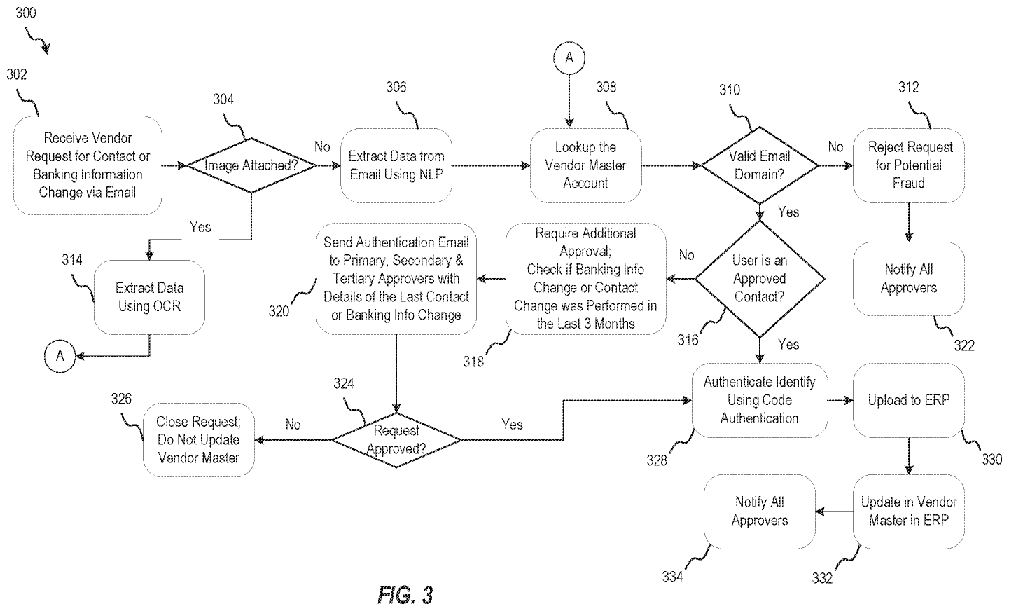

Referring to FIG. 2, another example of a system that supports automated account maintenance and fraud mitigation according to one or more aspects is shown as a system 200. In some implementations, the system 200 may include or correspond to the system 100 (or components thereof). As shown in FIG. 2, the system 200 includes a vendor contact 202, one or more clients 204, a server 208, and one or more external systems 232. Although the system 200 is described in the context of email requests, in other implementations, requests may include text messages (e.g., SMS messages), audio messages, or other types of messages, as further described above with reference to FIG. 1.

The vendor contact 202 (e.g., a vendor contact device) includes or corresponds to a contact at, or on behalf of a vendor that works with an entity for which the server 208 maintains secure accounts, such as vendor master accounts. As a non-limiting example, the entity may include a manufacturer, and the vendor contact 202 may include a parts supplier that supplies initial parts used by the manufacturer in the manufacture of a particular product, such as an automobile manufacture and an engine supplier, respectively. The vendor contact 202 may be configured to communicate requests to the server 208 to update a vendor account associated with the vendor contact 202. For example, the vendor contact 202 may send an email 206 to the server 208, the email 206 including a request to update an account associated with the vendor contact 202. The update may include changing a contact, changing a bank account or payment address, or the like, as described with reference to the request 170 of FIG. 1. In some implementations, the email 206 may include text data and an attachment, such as an image, a PDF file, a spreadsheet, or the like, that is part of the request.

The clients 204 (e.g., one or more client devices) may include one or more vendors (e.g., including the vendor associated with the vendor contact 202), one or more clients, or the like, with which the entity does business. As a non-limiting example, the clients 204 may include automobile sellers, one or more vehicle fleets, chassis suppliers, hull suppliers, wheel suppliers, electronics suppliers, and the like. Each of the clients 204 may be associated with a respective master account that is maintained by the server 208. Data stored in the respective accounts may be used by the entity for communicating with the clients 204, issuing payments to the clients 204, requesting payments from the clients 204, providing goods or services to the clients 204, and the like.

The server 208 is configured to maintain secure accounts for the entity with respect to the clients 204, such as vendor master accounts, client master accounts, and the like, and to update the accounts based on emails from the vendor contact 202 and the clients 204. In the example shown in FIG. 2, the server 208 includes an email bot 210 configured to automatically ingest and process emails (e.g., the email 206), an NLP text analyzer 212 configured to perform NLP operations on the email 206 to extract request data, in addition to OCR and machine learning (if needed), and case management 214 configured to apply business rules 220 to route and process requests, either automatically or by flagging some requests for manual inspection. The server 208 further includes a dashboard 216 configured to display information to and enable control by a user of one or more functions of the server 208, directed web access 218 configured to directly access various sources via the Internet, such as databases, websites, the external systems 232, or the like, and a security module 230 configured to support secured access to the server 208. The security module 230 may enable secured access to the server 208 based on information, identifiers, passwords, and the like, for administration 222 and one or more users 224, one or more roles 226 assigned to at least some of the users 224, one or more permissions 228 associated with at least some of the users 224, or a combination thereof.

The external systems 232 may include various functionality that is offloaded to external resources, such as cloud-based resources, to reduce a processing burden and memory footprint at the server 208. In the example shown in FIG. 2, the external systems 232 include an enterprise resource planning (ERP) system 234, artificial intelligence 236, and a geolocation service 242. The ERP system 234 is configured to provide business operations and support to the entity, such as by use of databases, workflows, rule-based systems, and the like. The ERP system 234 may be customized to integrate with one or more industry ERP systems. The artificial intelligence 236 may include different types of ML models, such as an OCR model 238 and a fraud detection model 240. The OCR model 238 may include one or more ML models that are trained to identify particular regions of non-plain text documents, such as images, PDF files, and the like, perform OCR on the identified regions, and otherwise extract information such as named entities, particular values, and the like. In some implementations, the OCR model 238 may include or correspond to the set of ML models 124 of FIG. 1. The fraud detection model 240 may include one or more ML models and/or one or more DL models that are trained based on fraudulent and legitimate email requests (e.g., a labeled email history) to identify or predict fraudulent requests. Such prediction may be achieved by output for a fraud score for an input email. In some implementations, the fraud detection model 240 may include or correspond to the first set of ML models 128 and/or the second set of DL models 130 of FIG. 1. The geolocation service 242 may be configured to provide geolocation data associated with the sender of an email. For example, the geolocation service 242 may provide GPS coordinates for the vendor contact 202, an address of the vendor contact 202, or the like. Although the external systems 232 are shown as including three types of systems, in other implementations, the external systems 232 may include fewer or more systems than illustrated in FIG. 2, such as a domain identification and registration system, as a non-limiting example.

To support secure account maintenance and updates, the system 200 may be configured such that a vendor account change request goes through an automated approval process before being committed to the vendor master account. Once approved, the account change request is committed to the ERP system 234 automatically for quick implementation. Using the email bot 210, the server 208 may be configured to ingest and process multiple request formats: plain text emails, PDF forms, and scanned documents, as non-limiting examples. In some implementations, the server 208 may be configured to authenticate validated emails, similar to as described above with reference to FIG. 1, including communicating with approved contacts or the requestor, optionally using 2-factor authentication to confirm the identities of both the requester and the approver of a request. The 2-factor or multi-factor authentication may include sending a one-time code to approved contacts through email, SMS message, or any other messaging technique. The geolocation service 242 enables validation of the vendor contact 202 based on the location of the vendor contact 202. Additionally or alternatively, the server 208 may reduce or prevent risk exposure of email requests using the fraud detection model 240 to predict the propensity that an individual request is fraudulent. Further, the dashboard 216 may provide a user of the server 208 with valuable insights into the vendor management process, such as the authentication process and fraud mitigation.

Referring to FIG. 3, a flow diagram of an example of a method for automated account maintenance and fraud mitigation according to one or more aspects is shown. In some implementations, the operations of the method 300 may be stored as instructions that, when executed by one or more processors (e.g., the processors of a computing device or server), cause the one or more processors to perform the operations of the method 300. In some implementations, the method 300 may be performed by a server, such as the server 102 of FIG. 1, the server 208 of FIG. 2, or a combination thereof. Although described in the context of vendor master accounts, the method 300 may be applied to secure maintenance and fraud mitigation of any type of accounts. Additionally or alternatively, although the method 300 is described for email requests, the operations described herein may be performed for other types of requests, such as SMS messages, audio messages, or the like, as further described above with reference to FIG. 1.

The method 300 includes receiving a vendor request for a contact or banking information change via email, at 302. For example, the email may include or correspond to the request 170 of FIG. 1 or the email 206 of FIG. 2. The method 300 includes determining whether an image (or other non-plain text document, such as a PDF file) is attached to the email, at 304. If the email does not include such an attachment, the method 300 continues to 306, and request data is extracted from the email using NLP. For example, the request data may include or correspond to the request data 110 of FIG. 1, which is extracted by the extraction engine 122 using NLP, as described above with reference to FIG. 1. After extracting the request data, the method 300 progresses to 308.

Returning to 304, if the email includes such an attachment (e.g., an image, PDF file, etc.), request data is extracted using OCR, at 314. For example, OCR may be performed on the attachment to convert unformatted image data to text data, or the OCR may be performed using ML models, as described with reference to FIGS. 1-2. After extracting the request data, the method 300 progresses to 308. The method 300 includes looking up the vendor master account (e.g., a vendor master file), at 308. For example, an account identifier included in the request information extracted from the email (or attachment) may be used to lookup the vendor master account associated with the account identifier. The vendor master account may include various information associated with a particular vendor, such as a name, a mailing address, a phone number, an email address, one or more designated contacts, one or more approved contacts, a payment address, a bank account or other financial account, location information, domain information, one or more rules or procedures, other information, or a combination thereof.

The method 300 includes determining whether an email domain corresponding to the is a valid email domain, at 310. For example, the email domain may be determined by accessing a domain service based on the email, and the email domain (e.g., a domain name, an IP address, registration information, etc.) may be compared to domain information stored in the vendor master account. If the email domain matches the domain information from the vendor master account, the email domain is determined to be valid. If the email domain is not valid, the method 300 continues to 312, and the request indicated by the email is rejected for potential fraud. The method 300 also includes notifying all approvers (of the rejection), at 322. For example, the approved contacts indicated by the vendor master account may be contacted by sending a message that indicates a request to update the vendor master account has been rejected for potential fraud. The message may indicate the account, the user from which the email is received, the requested update to the vendor master account, why the request was rejected, other information, or a combination thereof. Although notification to the approved contacts is described, in other implementations, one or more fraud prevention or compensation actions may be performed, such as flagging the request for manual inspection, performing a more detailed validation process for the email, delaying action on the requested update for a waiting period, increasing an exposure level of the vendor master account, other actions, or a combination thereof. Additionally, although determining whether the email domain is valid is described at 310, in other implementations, any number of validation operations described herein may be performed, in addition to or instead of validating the email domain, and the determination at 310 may include whether each validation operation is successful or whether a threshold number of validation operations are successful. Additionally or alternatively, validation may be dependent upon whether a fraud score generated for the email (e.g., using rules, ML model(s), DL model(s), or a combination thereof) is less than a threshold.

Returning to 310, if the email domain is valid (e.g., if validation is successful based on any validation metric described herein), the method 300 progresses to 316, and a determination whether a user (from which the email is received) is an approved contact is made. For example, the user may be compared to a list of approved contacts indicated by the vendor master account for the account that corresponds to the requested update indicated by the email. If the user is not an approved contact, the method 300 continues to 318, and an additional authentication/approval process is initiated. For example, the approved contacts for the account may be identified from the vendor master account, and a determination whether banking information or an approved contact was changed in the last three months is made. Such a determination may, in other implementations, be performed by determining a count of changes made during a monitoring period, such as one week, one month, three months, etc., which may correspond to the update count 118 of FIG. 1. The method 300 includes sending an authentication email to approved contacts with details of the last contact or banking information change, at 320. For example, the authentication email may include or correspond to the authentication request 172 of FIG. 1, and may include information such as the requested update, the user, the last contact or banking change, the update count 118, other information, or a combination thereof. In some implementations, the approved contacts may include a primary approver, a secondary approver, and a tertiary approver, which may include or correspond to the first approved contact 144, the second approved contact 146, and the third approved contact 148 of FIG. 1, respectively. The authentication email may be sent to all of the approved contacts, a subset of the approved contacts, or individually to each approved contact in a particular order, as described above with reference to FIG. 1.

The method 300 includes determining whether the request is approved, at 324. For example, the request may be approved if all of the approved contacts provide authentication responses that approve the request or if a threshold number of the approved contacts provide authentication responses that approve the request. The authentications responses may include emails, text messages, audio messages, or other types of messages. In some implementations, receipt of an authentication response indicates approval of the request (e.g., disapproval is indicated by failure to provide an authentication response). In some implementations, the authentication responses may be secured using 2-factor or other multi-factor authentication techniques. If the request is not approved, the method 300 continues to 326, and the request is closed and the vendor master account is not updated based on the email. For example, the vendor master account is not updated to change the approved contact, the bank account, or other update indicated in the email. In some implementations, a count of rejected requests may be updated, name(s) of approved contacts that did not approve the request may be stored, or a combination thereof. If the request is approved, the method 300 progresses to 328, and the identity of the user that submitted the email is authenticated using code authentication. For example, the user may be prompted to return an authentication code, such as the authentication code 178, using 2-factor or other multi-factor authentication techniques. Authenticating the user identity, even though the user has been identified as an approved contact, may reduce fraud in situations where a malicious actor, such as a hacker or corporate spy, initiated the email with the request unbeknownst to the user.

Returning to 316, if the user is an approved contact indicated by the vendor master account, the method 300 progress to 328, and the identity of the user is authenticated using code authentication, as described above. After the identity of the user is authenticated, the method 300 includes uploading the request indicated by the email to an ERP system, at 330. For example, the request that is extracted from the email may be provided to an ERP system that interfaces with a database that stores the vendor master accounts. The ERP system may include or correspond to the ERP system 234 of FIG. 2, in some examples. If the user identity is not authenticated (after one or more retries), the request may be closed, as described at 326. The method 300 includes updating the vendor master account in the ERP system, at 332. For example, an instruction to update the vendor master account, such as the update instruction 180 of FIG. 1, may be provided to the ERP system or from the ERP system to a secure account database that stores the vendor master accounts to cause updating of the vendor master account. The method 300 further includes notifying all approved contacts, at 334. For example, a notification message that indicates the update made to the vendor master account may be sent to any or all of the approved contacts indicated by the vendor master account. In some implementations, the notification is optional.

FIG. 4 shows an example of extracting information from a request for use in automated account maintenance according to one or more aspects. Although shown as an email in FIG. 4, in other implementations, the request may include an SMS message, an audio message, or another type of message, as further described above with reference to FIG. 1. In the example shown in FIG. 4, an email 400 includes text 402 and an attachment 404. The text 402 may include a title (“Insurance quote bill of sale attached”), one or more recipient email addresses, one or more return email addresses (“Kelly.wheeler@example.com”), an email body (“I need to add . . . ”), a signature or name (“Kelly Wheeler”), other information, or a combination thereof. The attachment 404 may include one or more files (“Motor_Vehicle_Bill_of_Sale.pdf”) that are included with the text 402 of the email 400. If the email is a legitimate (e.g., authentic) request, the attachment 404 may include additional information to further detail or support the legitimacy of the request. Alternatively, if the request is fraudulent or otherwise malicious, the attachment 404 may be fraudulent, or the attachment 404 may be legitimate and may be enclosed to increase credibility of the fraudulent response.

As described above with reference to FIGS. 1-2, one or more NLP operations may be performed on the text 402 to extract information items 410 for use creating a case report 430 to use to update a secure account, such as a vendor master account. One or more OCR operations (and subsequent NLP operations) may be performed on the attachment 404 to extract at least part of the information items 410. In some implementations, the information items 410 and/or the case report 430 may include or correspond to the request data 110 of FIG. 1. In the example shown in FIG. 4, the information items 410 include a language 412 associated with the text 402, a user (e.g., customer) 414 identified in the text 402 as the sender of the email 400, a sentiment 416 associated with the email 400, one or more files 418 attached to the email 400 (e.g., the attachment 406), one or more named entity values 420, and a requested update 422. The information items 410 may be extracted in order to identify relevant information for generating the case report 430, which may be used to validate the email 400 and to authenticate the requested update 422 by sending authentication requests to approved contacts, as described above with reference to FIGS. 1-3. If the email 400 is validated and the requested update 422 is authenticated, the requested update 422 may be made to a secure account, such as a vendor master account or client master account, indicated in the email 400.

As shown in FIG. 4, emails (or other requests) are analyzed using NLP text analysis to quickly understand a topic, see context, and automatically extract and map vital information. In some implementations, the emails may be analyzed using a conditional random field (CRF) algorithm, which is a statistical modeling method that is often applied to pattern recognition and is used for structure predictions. CRF is a sequence modeling method family that can take context into account, as compared to discrete models that predict a label for a single sample without considering neighboring samples. In some implementations, an ML model (or multiple ML models) may be created and trained based on the CRF algorithm to extract the information items 410 from emails. Data preparation for training the ML model may include defining entity types, providing data source(s), and sample construction.

In some implementations, the emails may include attachments, such as images of voided checks or deposit slips. A custom OCR model may be created to extract some or all of the information items 410, such as a magnetic ink character recognition (MICR) code, a routing number, and an account number, as non-limiting examples. Prior to being provided to the OCR model, the image may be pre-processed, such as by performing gray scale conversion, blurring, noise reduction, and thresholding, or other pre-processing operations. After the pre-processing, the vendor name and address may be extracted using one or more of erosion, dilution, blob creation, contour creation and detection, reading text using an open source Tesseract Library, or the like. Next, the account number and routing number may be detected by identifying areas having MICR digits, template matching, special character and pattern lookup, and using logical rules associated with account numbers and routing numbers (e.g., rules indicating which digits may have which values, where special characters are located, and the like). In some implementations, an application programming interface (API) may be hosted in the cloud and have firewall rules and security groups to manage security, such that the OCR model is only accessible as designed and by the correct parties. The information extract by the OCR model, such as any or all of the information items 410, may be provided to ML models, DL models, or both, for fraud prediction, as further described with reference to FIGS. 5A-C.

FIGS. 5A-C are diagrams of examples of machine learning and deep learning models configured to validate requests according to one or more aspects. The machine learning and deep learning models may be trained to predict whether an input request (e.g., an email, an SMS message, an audio message, etc.) is a fraudulent request, using an email history (or other message history) for an entity, generated training emails (or other messages), or both. The emails (or other messages) are labelled to indicate whether the emails are fraudulent or legitimate, and the models described with reference to FIGS. 5A-C are trained to predict whether an input email (or other message) is fraudulent based on learned underlying similarities to the labelled fraudulent emails (or other messages).

Referring to FIG. 5A, an example 500 of training machine learning models to predict fraudulent requests is shown. In the example 500, a corpus of emails (or other messages) may be divided into a training set 502 and a test set 510. The training set 502 may be segmented into first training data 504 (“Training Data 1”), second training data 506 (“Training Data 2”), and nth training data 508 (“Training Data n”), that are provided to a first ML model 512 (“Decision Tree 1”), a second ML model 514 (“Decision Tree 2”), and an nth ML model 516 (“Decision Tree n”), respectively. Although three ML models and corresponding training data are shown in FIG. 5A, in other implementations, there may be fewer than three or more than three ML models (e.g., n may be any integer greater than or equal to one). Additionally or alternatively, although decision trees are shown in FIG. 5A, in other implementations the ML models 512-516 may include or correspond to other types of ML models, such as NNs, SVMs, random forests, or the like. In some implementations, the ML models 512-516 include classification models such as random forests, logistic regression models, extreme gradient (XG) boost, or the like, and the best models are selected for implementation. The outputs of the ML models 512-516 are provided to a voting function 518 that is configured to average or otherwise aggregate the outputs to generate a prediction 520, which indicates whether an input email (or other message) is predicted to be fraudulent or legitimate. The ML models 512-516 may be tested using the test set 510, and training may continue until an accuracy of the prediction 520 satisfies a threshold, until a particular training time period has lapsed, until an increase in accuracy from one round of training to the next fails to satisfy a threshold, or using any other metric. In some implementations, the training data may include extracted features from historic emails, such as a requestor email address, email text, a vendor name, a vendor bank account, a vendor bank routing number, a vendor contract number, a vendor registered email address, a vendor registered address, one or more approved contact email addresses, a number of updates during a monitoring time period, an attachment indicator, an indicator of if the update is for the same bank account indicated in the email, an indicator if the update is for the same email domain as the email, or the like.

Referring to FIG. 5B, an example 530 of training deep learning models to predict fraudulent requests is shown. In the example 530, one or more DL models, such as one or more deep neural networks (DNNs), may be trained to predict whether input emails are fraudulent or legitimate. In some implementations, the one or more DL models may include bidirectional encoder representations from transformers (BERT) models. Training of the one or more DL models may include pre-training, followed by fine tuning. To illustrate, an initial DL model 532 may be trained on a known corpus to perform NLP. After the initial training, an email fraud classifier 534 may be created by training and fine-tuning one or more instances of the initial DL model 532 on the training set 502 and the test set 510, similar to as described with reference to FIG. 5A for the ML models 512-516. The training process may include hyperparameter tuning, such as by evaluating the DL models multiple times during each epoch and discarding hyperparameters (or models) that fail to satisfy one or more thresholds. In some implementations, the email fraud classifier 534 may output a binary value indicating whether an input email is predicted to be fraudulent (or legitimate). Alternatively, the email fraud classifier 534 may be configured to output a fraud score, such as by using voting or other aggregation techniques to generate a score based on multiple fraud predictions.

Referring to FIG. 5C, a system for predicting email fraud using machine learning and deep learning is shown as a system 580. The system 580 includes a trained ML model 582, a trained DL model 584, and an ensemble model 586 (or an ensemble gate). The trained ML model 582 may include one or more trained ML models, such as the ML models shown in FIG. 5A, that are configured to output a prediction of whether or not an input email (or other message) is fraudulent. The trained DL model 584 may include one or more trained DL models, such as the DL models shown in FIG. 5B, that are configured to output a prediction of whether or not an input email (or other message) is fraudulent. Although one trained ML model 582 and one trained DL model 584 are shown in FIG. 5C, in other implementations, more than one trained ML model 582, more than one trained DL model 584, or both, may be included in the system 580.

Outputs of the trained ML model 582 and the trained DL model 584 may be provided to the ensemble model 586. The ensemble model 586 may be configured to ensemble the outputs of the various ML and DL models. In some implementations, ensembling the outputs may include averaging the outputs, performing a weighted averaging of the outputs, or other types of aggregation operations. In some other implementations, the ensemble model 586 may include or correspond to one or more logic gates, such as an OR gate as a non-limiting example. The ensemble model 586 may generate an email fraud predictor 588. The email fraud predictor 588 may represent a final prediction of whether an input email is fraudulent or legitimate (e.g., authentic). In some implementations, the email fraud predictor 588 may be a binary value that indicates a prediction of fraudulent or legitimate. In other implementations, the email fraud predictor 588 may be a fraud score, such as a score on a scale of one to ten or zero to one hundred, as non-limiting examples.

In some implementations, the ensemble model 586 may be configured to weight the outputs of the different types of models differently based on the domain (e.g., the context) of the account to be updated. For example, weights 590 include pairs of weights that may be applied by the ensemble model 586 to the outputs of the trained ML model 582 and the trained DL model 584 for five illustrative domains: finance, retail, telecom, operations, and others. As a non-limiting example, a weight of 0.7 (e.g., 70%) may be applied to the output of the trained ML model 582 and a weight of 0.3 (e.g., 30%) may be applied to the output of the trained DL model 584 if the account is a finance account. The weights 590 may be selected based on analysis of the accuracy of the various models for the different domains/contexts.

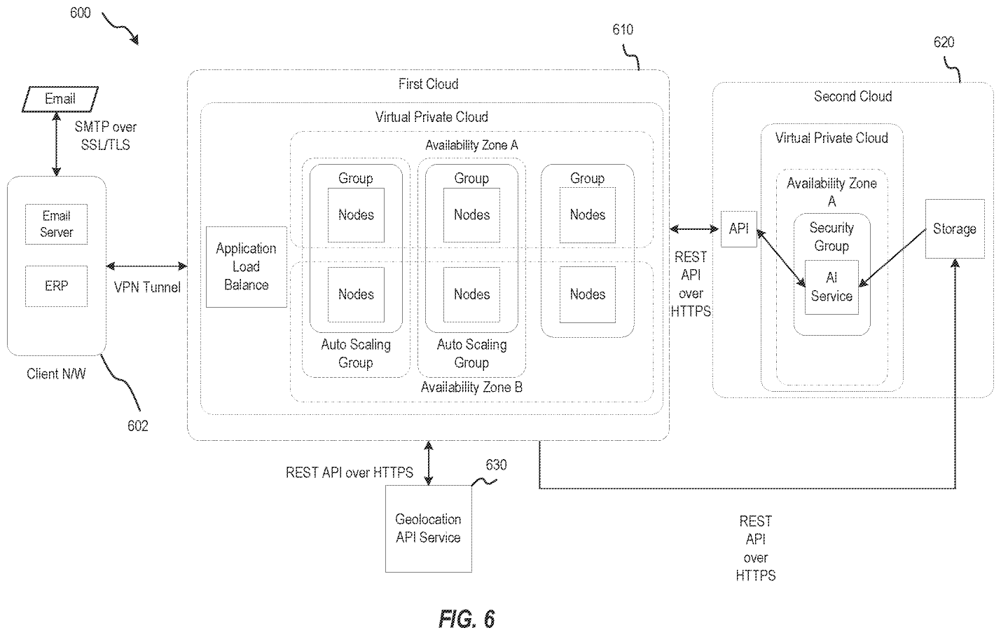

Referring to FIG. 6, an example of a cloud-based implementation of a system that supports automated account maintenance and fraud mitigation according to one or more aspects is shown as a system 600. In some implementations, the system 600 may include or correspond to the system 100 (or components thereof), the system 200 (or components thereof), or a combination thereof. As shown in FIG. 6, the system 600 includes a client network 602, a first cloud 610, a second cloud 620, and a geolocation API service 630. In some implementations, the system 600 may include different or additional components, such as a domain lookup or registration service, as a non-limiting example.

The client network 602 may be configured to perform various operations related to providing business solutions and support to a client, in addition to acting as an entry point for maintaining secure accounts of the client, such as vendor master accounts, client master accounts, and the like. For example, the client network 602 may receive and process email requests, or other types of requests, for updating or modifying the secure accounts, as well as performing ERP-related operations. The client network 602, upon receiving an email request, may provide the email request to the first cloud 610, such as via a secure connection including a virtual private network (VPN) tunnel, as a non-limiting example.

The first cloud 610 may be configured to validate the email request, as described above with reference to FIGS. 1-3. The validation may include interaction with other systems, such as the second cloud 620 and the geolocation API service 630. For example, the second cloud 620 may store and implement an application programming interface (API), cloud storage, and AI services, such as one or more ML models configured to OCR email requests, one or more ML models configured to extract information from request emails, one or more ML models configured to predict whether email requests are fraudulent, one or more DL models configured to predict whether email requests are fraudulent, or a combination thereof, as described above. As another example, the geolocation API services 630 may be configured to provide geolocation data associated with senders of email requests for use in validating the email requests by the first cloud 610. To further illustrate, an originating IP address of an email request may be passed to the geolocation API services 630, and the first cloud 610 may receive a country, region, city, currency, and internet service provider (ISP) associated with the sender. Additionally or alternatively, the first cloud 610 may be configured to authenticate the email requests. For example, the first cloud 610 (via interaction with the client network 602) may transmit authentication requests to approved contacts to authenticate email requests, as described above with reference to FIGS. 1-3. The first cloud 610 may also be configured to store and update the secure client accounts (or to interact with remote databases that store the secure accounts), to support automated account management and updating with reduced exposure to fraud.

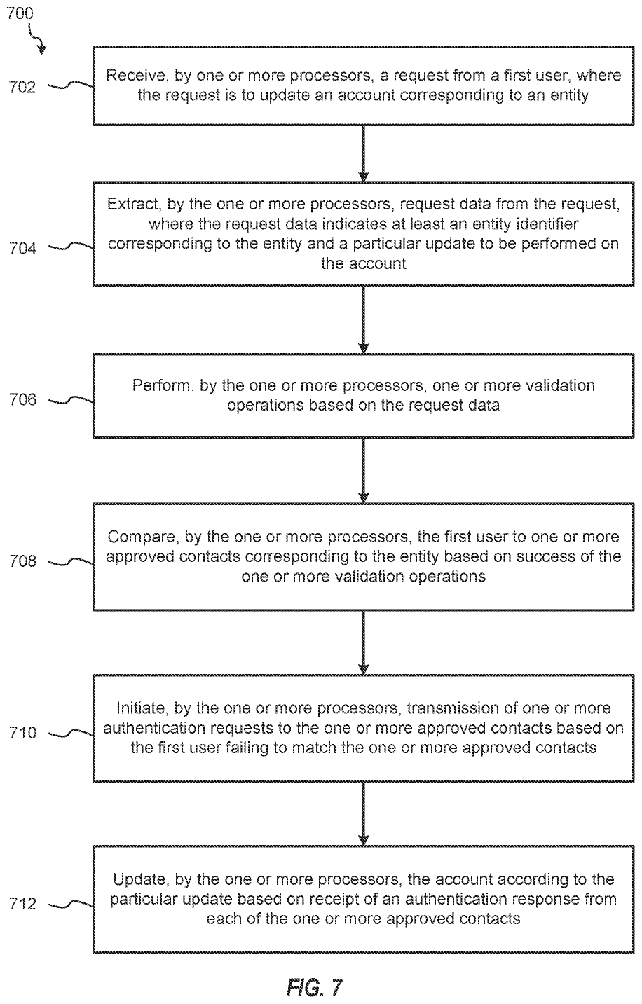

Referring to FIG. 7, a flow diagram of an example of a method for automated account maintenance and fraud mitigation according to one or more aspects is shown as a method 700. In some implementations, the operations of the method 700 may be stored as instructions that, when executed by one or more processors (e.g., the one or more processors of a computing device or a server), cause the one or more processors to perform the operations of the method 700. In some implementations, the method 700 may be performed by a computing device, such as the server 102 of FIG. 1 (e.g., a computing device configured for secure account maintenance and fraud mitigation), the server 208 of FIG. 2, one or more components of the system 600 of FIG. 6, or a combination thereof.

The method 700 includes receiving a request from a first user, at 702. The request is to update an account corresponding to an entity. For example, the request may include or correspond to the request 170 of FIG. 1. The method 700 includes extracting request data from the request, at 704. The request data indicates at least an entity identifier corresponding to the entity and a particular update to be performed on the account. For example, the request data may include or correspond to the request data 110 of FIG. 1.

The method 700 includes performing one or more validation operations based on the request data, at 706. For example, the validation engine 126 of FIG. 1 may perform validation operations on the request data 110, and other data such as the geolocation data 112, the domain information 114, and the like. The method 700 includes comparing the first user to one or more approved contacts corresponding to the entity based on success of the one or more validation operations, at 708. For example, the one or more approved contacts may include or correspond to the one or more approved contacts 142 of FIG. 1.

The method 700 includes initiating transmission of one or more authentication requests to the one or more approved contacts based on the first user failing to match the one or more approved contacts, at 710. For example, the one or more authentication requests may include or correspond to the authentication request 172 of FIG. 1. The method 700 includes updating the account according to the particular update based on receipt of an authentication response from each of the one or more approved contacts, at 712. For example, the authentication response may include or correspond to the authentication response 174 of FIG. 1.

In some implementations, the request data further indicates an account identifier corresponding to the account, and performing the one or more validation operations includes comparing the entity identifier and the account identifier to account data corresponding to a plurality of accounts. Each account of the plurality of accounts corresponds to a respective entity. For example, the validation engine 126 may compare an entity identifier and an account identifier included in the request data 110 to corresponding identifiers associated with an account stored at the account database 150. Additionally or alternatively, the method 700 may include obtaining geolocation data corresponding to the first user, a domain name corresponding to the first user, or both. Performing the one or more validation operations includes comparing the geolocation data, the domain name, or both, to geolocation data corresponding to the entity, a domain name corresponding to the entity, one or more restricted locations, one or more restricted domains, or a combination thereof. For example, the validation engine 126 may compare the geolocation data 112, the domain information 114, or both, to corresponding information stored in the respective account at the account database 150, to a list of restricted locations, to a list of restricted domains, or a combination thereof.

In some implementations, performing the one or more validation operations includes providing the request data as input data to one or more ML models to generate a fraud score, and comparing the fraud score to a threshold. The one or more ML models are configured to generate fraud scores based on input request data. For example, the one or more ML models may include or correspond to the first set of ML models 128, the second set of DL models 130, or both, of FIG. 1, and the fraud score may include or correspond to the fraud scores 116 of FIG. 1. In some such implementations, the one or more ML models are implemented at an external server, providing the request data as the input data to the one or more ML models comprises transmitting the input data to the external server, and the fraud score is received from the external server. For example, the external server may include or correspond to the external systems 232 of FIG. 2. Additionally or alternatively, the one or more ML models include a first set of one or more ML models, the one or more ML models include a second set of one or more DL models, and the fraud score is based on an ensembling of outputs of the first set of ML models and the second set of DL models. For example, the first set of ML models may include or correspond to the first set of ML models 128 of FIG. 1, and the second set of DL models may include or correspond to the second set of DL models 130 of FIG. 1. The ensembling may be performed as further described with reference to FIG. 5C.

In some implementations, the method 700 may also include initiating transmission of an authentication message to the first user based on the first user matching one of the one or more approved contacts, and updating the account according to the particular update based on receipt of an authentication code from the first user. For example, the authentication message may include or correspond to the authentication message 176 of FIG. 1. Additionally or alternatively, the one or more approved contacts include multiple contacts, and the account is updated based on receipt of a respective authorization response from each of the multiple contacts. For example, the multiple contacts may include or correspond to the approved contacts 142 of FIG. 1. In some such implementations, the multiple contacts include a primary approved contact, a secondary approved contact, and a tertiary approved contact. For example, the primary approved contact may include or correspond to the first approved contact 144 of FIG. 1, the secondary approved contact may include or correspond to the second approved contact 146 of FIG. 1, and the tertiary approved contact may include or correspond to the third approved contact 148 of FIG. 1.

In some implementations, the one or more authentication requests indicate a number of updates to the account during a monitoring period, and the one or more authentication requests are transmitted based on the number of updates failing to satisfy a threshold. For example, the number of updates may include or correspond to the update count 118 of FIG. 1. Additionally or alternatively, the method 700 may further include initiating performance of a fraud detection operation based on failure of the one or more validation operations or a failure to receive the authentication response from each of the one or more approved contacts within a threshold time period. For example, the fraud detection operation may be initiated based on the validation engine 126 failing to validate the request 170 or based on failure to receive the authentication responses 174.

In some implementations, the request includes an email or a SMS message. Additionally or alternatively, extracting the request data from the request may include performing one or more NLP operations on the request. For example, the extraction engine 122 may perform one or more NLP operations on the request 170 to generate the request data 110. Additionally or alternatively, the request may include an image, and extracting the request data from the request may include performing one or more OCR operations on the image to generate text data and performing one or more NLP operations on the text data. For example, the extraction engine 122 may perform one or more OCR operations on the request 170 (or an attachment) to generate text data, and the extraction engine 122 may perform one or more NLP operations on the text data to generate the request data 110. In some such implementations, performing the one or more OCR operations includes providing the image as input data to one or more ML models configured to identify regions to perform OCR on input images. For example, the one or more ML models may include or correspond to the set of ML models 124 of FIG. 1.

In some implementations, account data for the account is stored at an external database, and updating the account includes transmitting, to the external database, an update instruction that indicates the particular update. For example, the external database may include or correspond to the account database 150 of FIG. 1, and the update instruction may include or correspond to the update instruction 180 of FIG. 1. Additionally or alternatively, the entity includes a vendor or a client, and the account includes a vendor master account corresponding to the vendor or a client master account corresponding to the client. Additionally or alternatively, particular update includes adding an approved contact to the one or more approved contacts, changing one of the one or more approved contacts, changing an address corresponding to the account, changing a financial account corresponding to the account, or a combination thereof.

As described above, the method 700 supports secure account maintenance and fraud mitigation for accounts such as vendor master accounts, as a non-limiting example. Because a fraudulent request (e.g., a request sent from a malicious entity or from a user that unknowingly has their device hijacked) undergoes both validation and authentication by the approved contacts (or the user if the user is an approved contact) before an account is updated based on the request, security of the accounts is maintained without requiring manual inspection of the request.

It is noted that other types of devices and functionality may be provided according to aspects of the present disclosure and discussion of specific devices and functionality herein have been provided for purposes of illustration, rather than by way of limitation. It is noted that the operations of the method 300 of FIG. 3 and the method 700 of FIG. 7 may be performed in any order, or that operations of one method may be performed during performance of another method, such as the method 300 of FIG. 3 including one or more operations of the method 700 of FIG. 7. It is also noted that the method 300 of FIG. 3 and the method 700 of FIG. 7 may also include other functionality or operations consistent with the description of the operations of the system 100 of FIG. 1, the system 200 of FIG. 2, the ML and DL models of FIGS. 5A-C, or the system 600 of FIG. 6.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-7) include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules, and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may also be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

What is claimed is:

1. A method for automated account maintenance and fraud mitigation, the method comprising:
receiving, by one or more processors, a request from a first user,
wherein the request is to update an account corresponding to an entity;
extracting, by the one or more processors, request data from the request,
wherein the request data indicates at least an entity identifier corresponding to the entity and a particular update to be performed on the account;
performing, by the one or more processors, one or more validation operations based on the request data;
comparing, by the one or more processors, the first user to one or more approved contacts corresponding to the entity based on success of the one or more validation operations;
initiating, by the one or more processors, transmission of one or more authentication requests to the one or more approved contacts based on the first user failing to match the one or more approved contacts; and
updating, by the one or more processors, the account according to the particular update based on receipt of an authentication response from each of the one or more approved contacts.

2. The method of claim 1, wherein:
the request data further indicates an account identifier corresponding to the account, and
performing the one or more validation operations includes comparing the entity identifier and the account identifier to account data corresponding to a plurality of accounts, each account of the plurality of accounts corresponding to a respective entity.

3. The method of claim 1, further comprising obtaining, by the one or more processors, geolocation data corresponding to the first user, a domain name corresponding to the first user, or both,
wherein performing the one or more validation operations includes comparing the geolocation data, the domain name, or both, to geolocation data corresponding to the entity, a domain name corresponding to the entity, one or more restricted locations, one or more restricted domains, or a combination thereof.

4. The method of claim 1, wherein performing the one or more validation operations includes:
providing, by the one or more processors, the request data as input data to one or more machine learning (ML) models to generate a fraud score,
wherein the one or more ML models are configured to generate fraud scores based on input request data; and
comparing, by the one or more processors, the fraud score to a threshold.

5. The method of claim 4, wherein:
the one or more ML models are implemented at an external server,
providing the request data as the input data to the one or more ML models comprises transmitting the input data to the external server, and
the fraud score is received from the external server.

6. The method of claim 4, wherein:
the one or more ML models include a first set of one or more ML models,
the one or more ML models include a second set of one or more deep learning (DL) models, and
the fraud score is based on an ensembling of outputs of the first set of ML models and the second set of DL models.

7. The method of claim 1, further comprising:
initiating, by the one or more processors, transmission of an authentication message to the first user based on the first user matching one of the one or more approved contacts; and
updating, by the one or more processors, the account according to the particular update based on receipt of an authentication code from the first user.

8. The method of claim 1, wherein:
the one or more approved contacts include multiple contacts, and
the account is updated based on receipt of a respective authorization response from each of the multiple contacts.

9. The method of claim 8, wherein the multiple contacts include a primary approved contact, a secondary approved contact, and a tertiary approved contact.

10. The method of claim 1, wherein:
the one or more authentication requests indicate a number of updates to the account during a monitoring period, or
the one or more authentication requests are transmitted based on the number of updates failing to satisfy a threshold.

11. The method of claim 1, further comprising initiating, by the one or more processors, performance of a fraud detection operation based on failure of the one or more validation operations or a failure to receive the authentication response from each of the one or more approved contacts within a threshold time period.

12. A device for automated account maintenance and fraud mitigation, the device comprising:
a memory; and
one or more processors communicatively coupled to the memory, the one or more processors configured to:
receive a request from a first user,
wherein the request is to update an account corresponding to an entity;
extract request data from the request,
wherein the request data indicates at least an entity identifier corresponding to the entity and a particular update to be performed on the account;
perform one or more validation operations based on the request data;
compare the first user to one or more approved contacts corresponding to the entity based on success of the one or more validation operations;
initiate transmission of one or more authentication requests to the one or more approved contacts based on the first user failing to match the one or more approved contacts; and
update the account according to the particular update based on receipt of an authentication response from each of the one or more approved contacts.

13. The device of claim 12, wherein the request comprises an email or a short message service (SMS) message.

14. The device of claim 12, wherein the one or more processors are configured to extract the request data from the request by performing one or more natural language processing (NLP) operations on the request.

15. The device of claim 12, wherein:
the request includes an image, and
the one or more processors are configured to extract the request data from the request by:
performing one or more optical character recognition (OCR) operations on the image to generate text data; and
performing one or more natural language processing (NLP) operations on the text data.

16. The device of claim 15, wherein the one or more processors are configured to perform the one or more OCR operations by providing the image as input data to one or more machine learning (ML) models configured to identify regions to perform OCR on input images.

17. A non-transitory computer-readable storage medium storing instructions that, when executed by one or more processors, cause the one or more processors to perform operations for automated account maintenance and fraud mitigation, the operations comprising:
receiving a request from a first user,
wherein the request is to update an account corresponding to an entity;
extracting request data from the request,
wherein the request data indicates at least an entity identifier corresponding to the entity and a particular update to be performed on the account;
performing one or more validation operations based on the request data;
comparing the first user to one or more approved contacts corresponding to the entity based on success of the one or more validation operations;
initiating transmission of one or more authentication requests to the one or more approved contacts based on the first user failing to match the one or more approved contacts; and
updating the account according to the particular update based on receipt of an authentication response from each of the one or more approved contacts.

18. The non-transitory computer-readable storage medium of claim 17, wherein:
account data for the account is stored at an external database, and
updating the account comprises transmitting, to the external database, an update instruction that indicates the particular update.

19. The non-transitory computer-readable storage medium of claim 17, wherein:
the entity comprises a vendor or a client, and
the account comprises a vendor master account corresponding to the vendor or a client master account corresponding to the client.

20. The non-transitory computer-readable storage medium of claim 17, wherein the particular update comprises adding an approved contact to the one or more approved contacts, changing one of the one or more approved contacts, changing an address corresponding to the account, changing a financial account corresponding to the account, or a combination thereof.
